(19) United States
(12) Patent Application Publication
(10) Pub. No.: US 2012/0305351 A1
(43) Pub. Date: Dec. 6, 2012

(54) DAMPER DEVICE

(75) Inventors: Nils Kopto, Bad Mergentheim (DE); Erik Mario Arnold, Gorxheimertal (DE)

(73) Assignee: ILLINOIS TOOL WORKS, INC., Glenview, IL (US)

(21) Appl. No.: 13/577,308

(22) PCT Filed: Feb. 11, 2011
(86) PCT No.: PCT/US2011/024562

§ 371 Date: Aug. 6, 2012

(30) Foreign Application Priority Data
Feb. 12, 2010 (DE) 10 2010 009 375.0

(51) Int. Cl. F16F 9/12

(52) U.S. Cl. 188/272

(57) ABSTRACT

A damper device for damping the movement of a component, preferably of a component mounted in a movable manner in the interior of a motor vehicle, comprising a damper housing, which delimits a damper cavity in which a rotor is arranged such that it can be rotated about an axis of rotation, wherein the rotor is connected in a rotationally fixed manner to a force transmitting element arranged outside the damper housing, and wherein the force transmitting element is connected to the component such that it is actuated upon movement of the component, characterized in that the damper housing has a first surface located in a plane running perpendicularly to the axis of rotation, in that the force transmitting element comprises a disk which has a second surface likewise located in a plane running perpendicularly to the axis of rotation, wherein the first and second surfaces are located opposite one another, in that a locking pin is retained axially on the first surface or on the second surface, and in that a groove which forms a locking curve is formed in the respectively other of the first and second surfaces, wherein the locking pin engages with the groove, and wherein the locking pin, upon actuation of the force transmitting element, is guided in the groove such that the force transmitting element can be locked in a releasable manner in relation to the damper housing.

The invention relates to a damper device for damping the movement of a component, preferably of a component mounted in a movable manner in the interior of a motor vehicle, comprising a damper housing, which delimits a damper cavity in which a rotor is arranged such that it can be rotated about an axis of rotation, wherein the rotor is connected in a rotationally fixed manner to a force transmitting element arranged outside the damper housing, likewise such that it can be rotated about the axis of rotation, and wherein the force transmitting element is connected to the component such that it is actuated upon movement of the component.

Such damper devices are used, for example, in automobiles for damping the movement of coverings for ashtrays. Conventional coverings are provided with a damper on one side and with a hinge, to provide for a pivoting movement of the covering, on another, opposite side. The disadvantage here is the comparatively high design complexity and the comparatively large amount of space required on account of the spatial separation of the damper from the hinge.

WO 2004/085777 A1 diskloses a damper device for a door or drawer. This damper device has a damper housing with a damper cavity in which a rotor is arranged for rotation. Provided between an underside of the rotor and a housing-base inner surface, which is located opposite, is a locking arrangement which comprises a groove, formed in particular in the underside of the rotor, and a pivot arm, arranged on the opposite inner side of the housing base. The pivot arm is mounted such that it can be pivoted about a pivot axis and, upon rotation of the gearwheel connected to the rotor, it is guided in the locking curve. In the case of another exemplary embodiment described in WO 2004/085777 A1, there is no gearwheel provided. Rather, in the case of this exemplary embodiment, the arrangement is provided directly on the pivot axis of the door which is to be damped. The locking arrangement with the locking groove and the pivotable arm element, in the case of this exemplary embodiment, are laterally remote from the damper cavity between the housing underside and a housing covering located opposite. A similar arrangement is known from WO 2005/040535 A1. Once again, a locking arrangement formed from a locking groove and a pivotable arm element is provided between the underside of the rotor and a housing-base inner surface, which is located opposite. EP 1 348 827 B1 also diskloses a damper with a locking arrangement provided within the damper cavity.

The known dampers have the disadvantage of a complex design and, in some cases, also a considerable overall size. Moreover, the medium used for damping purposes, for example a damper fluid, may influence the locking arrangement in undesirable ways.

Proceeding from the prior art explained above, it is an object of the invention to provide a damper device of the type mentioned in the introduction which is distinguished by a straightforward design, a compact size and good robustness during operation.

This object is achieved according to the invention by the subject matter of claim 1. Advantageous configurations are to be found in the dependent claims, the description and the figures.

For a damper device of the type mentioned in the introduction, the object is achieved by the invention
in that the damper housing has a first surface located in a plane running perpendicularly to the axis of rotation,
in that the force transmitting element comprises a disk which has a second surface likewise located in a plane running perpendicularly to the axis of rotation, wherein the first and second surfaces are located opposite one another,
in that a locking pin is retained axially on the first surface or on the second surface, and
in that a groove which forms a locking curve is formed in the respectively other of the first and second surfaces, wherein the locking pin engages with the groove, and wherein the locking pin, upon actuation of the force transmitting element, is guided in the groove such that the force transmitting element can be locked in a releasable manner in relation to the damper housing.

The component may be, for example, a covering for storage compartments, ashtrays or the like in the interior of an automobile. The component may be movable between a closed position and an open position. It may be displaceable, for example, along a transaction axis or pivotable about a pivot axis or movable in some other way. The movement of the component is coupled to the force transmitting element such that, when the component moves, the force transmitting element likewise moves. For this purpose, the component may have connected to it, for example, a rack which engages with the force transmitting element and thus couples movement of the component to movement of the force transmitting element. The rack may be, for example, curved. The component may be prestressed, for example, into an open position. This can be achieved by a suitable spring element and/or on account of the dead weight of the component.

The force transmitting element may be arranged on the disk. It may be connected, for example, in one piece to the disk. The locking pin is retained on the appropriate surface such that it is fixed in the direction of its longitudinal axis. The locking pin may also be fixed in the circumferential direction of the respective surface retaining it. However, it may have an amount of play, for example, in the axial direction, in order to compensate for installation and component tolerances. The locking pin may have, for example, two flange-like locking portions, between which it is retained on the surface which carries it. By way of its other end, the locking pin is guided in the groove forming the locking curve. By virtue of the disk being arranged in relation to the damper housing so as to be fixed in the direction of the axis of rotation, the locking pin is retained such that it cannot move axially either out of the surface carrying it or out of the groove. Upon actuation or movement of the force transmitting element, the locking pin is then guided along the locking curve formed by the groove. In particular upon movement of the force transmitting element in a first direction, it is possible for the locking pin to be guided up to a locking portion of the locking curve and to be locked in a releasable manner thereon. In this state, it is also the case that the disk is locked, with the force transmitting element, in relation to the damper housing, and thus therefore prevents movement of the force transmitting element in relation to the damper housing at least in a second direction, which is counter to the first direction. The component is then also locked in respect of a corresponding movement. The locking pin can be released again from this locked position, and therefore the force transmitting element can also be moved again in relation to the damper housing, in particular in a direction counter to the first direction. The component can thus also be moved again correspondingly.

According to the invention, there is therefore no need for any pivotable arm for locking and unlocking purposes. This simplifies the design, and helps with the robustness, of the damper according to the invention. Furthermore, the locking arrangement, comprising locking pin and groove, according to the invention is located between the damper housing and the force transmitting element, that is to say in particular outside the damper cavity and in particular outside the damper-housing arrangement as a whole. There is therefore spatial separation from the damper cavity. This reliably avoids the situation where the locking arrangement is influenced in undesirable ways by a damper medium located in the damper cavity. Such an influence can become apparent in the prior art, in particular if use is made of damper fluids, in the event of changes in viscosity brought about by fluctuations in temperature. According to the invention, the locking function remains unaffected by such influences. Even if the locking device is damaged, for example the locking pin is fractured, there is no chance of the damper behavior being influenced in an undesirable manner. If, on the other hand, there should be any damage to the damper in the damper cavity, this does not affect the locking function in any way. Moreover, the fact that the locking device is designed according to the invention to be outside the damper housing provides for a high level of flexibility. It is thus straightforwardly possible, for example by changing the geometry of the locking pin and/or of the locking curve (e.g. making the locking pin and/or the locking curve thicker and/or adapting the length of the locking curve) to adapt the locking function, for example to change moments which are to be transmitted. Such changes in geometry can be realized in a considerably more straightforward and flexible manner outside the damper cavity, for example in a housing cover or on the disk. Furthermore, the spatial separation between the locking function and the damper function gives largely free range in respect of the damper medium, for example in respect of the viscosity of a damper fluid.

Furthermore, according to the invention, the connection of the damper and locking means provides for a relatively large amount of space within an opening which is closed by the covering which is to be damped. It is possible for the damper device according to the invention for example to be screw-connected or latched directly to a pivot axis of a covering or shutter which is to be damped. In addition, all that is required is an integrated damping and locking system, without different arrangements having to be adapted to one another in this respect.

That surface of the damper housing which is provided with the groove or the locking pin may be, in particular, the upper side of a housing cover. The respectively other element, either the locking pin or groove, may be arranged on that side of the damper housing, in particular of the housing cover, which is directed away from the damper cavity, and opposite the damper cavity. This gives rise to a particularly compact construction. Provision may be made for the locking pin to be retained on the disk and for the groove to be formed in a damper-housing cover.

According to a particularly practical configuration, the force transmitting element may be a gearwheel which, for actuation in a first and a second direction of actuation, can be rotated about the axis of rotation in a first or second direction of rotation. The disk may then, correspondingly, be a gearwheel disk. It is also conceivable, however, for the force transmitting element to be a driver or an arm, in particular a lever arm. Such a driver or arm may be latched, for example, to the disk.

According to a further particularly practical configuration, it may be provided that, starting from a beginning of the locking curve, the locking pin, upon actuation of the force transmitting element in a first direction of actuation, for example upon rotation of the gearwheel in a first direction of rotation, is locked, at one end of the locking curve, in a locking position in which actuation of the force transmitting element in a second, opposite direction of actuation, for example rotation of the gearwheel in a second, opposite direction of rotation, is prevented, and that the locking pin located in the locking position, upon further actuation of the force transmitting element in the first direction of actuation, for example upon further rotation of the gearwheel in the first direction of rotation, is released from the locking position, and therefore the force transmitting element can be actuated in the second direction of actuation, for example the gearwheel can be rotated in the second direction of rotation, wherein the locking pin is guided back to the beginning of the locking curve.

According to this configuration, the locking arrangement is thus a locking arrangement with push-push kinematics. In the case of the locking pin being located in the locking position, the force transmitting element is (over-)actuated in the first direction, for example a gearwheel is (over-)rotated in this direction. This releases the locking and the force transmitting element can be actuated in the opposite direction, for example a gearwheel can be rotated in the opposite direction, wherein the locking pin is guided back to the beginning of the locking curve. It is further possible for the locking curve to have a heart curve at its end. This achieves the releasable locking in a particularly practical and operationally reliable manner. Heart curves are known per se to a person skilled in the art. Their name derives from their shape. Starting from the beginning of the locking curve, the locking pin, upon actuation of the force transmitting element in the first direction of actuation, for example upon rotation of a gearwheel in the first direction of rotation, is guided along a first path to the end of the locking curve, where the locking pin is locked on a suitable locking surface. Upon further movement of the force transmitting element, for example upon over-rotation of a gearwheel, and thus over-rotation of the locking pin in the first direction of rotation, the locking pin, starting from the end of the locking curve, is released from the locking surface and, upon subsequent actuation of the force transmitting element in the second direction of actuation, for example upon rotation of a gearwheel in the second direction of rotation, is guided back to the beginning along a different, second path. The locking curve may run in circular or helical form between the beginning and the end. The helix here may have one or more helix turns, depending on the rotations which have to be executed by a gearwheel, for example, between an open position and a closed position of a covering.

For example in order to be able to follow the progression of a heart curve, the locking pin has to be mounted in a movable manner in the radial direction. Correspondingly, according to a further configuration, the locking pin may be mounted such that it can be moved in a radial direction in relation to the axis of rotation. For this purpose, the locking pin may be mounted such that it can be moved radially in a radial aperture in the first surface or the second surface. The aperture here may be open in particular in the direction of the periphery of the respective first or second surface.

According to a further particularly practical configuration, the rotor may have a shank which projects out of the damper housing through the first surface and is connected in a rotationally fixed manner to the disk.

In a manner known per se, the damper housing may have arranged in it a damper fluid, in particular a silicone fluid, in which the rotor rotates upon actuation of the force transmitting element.

Some or all of the parts of the damper device may be produced from a plastics material, for example by injection molding.

An exemplary embodiment of the invention will be explained in more detail hereinbelow with reference to figures, in which, schematically:

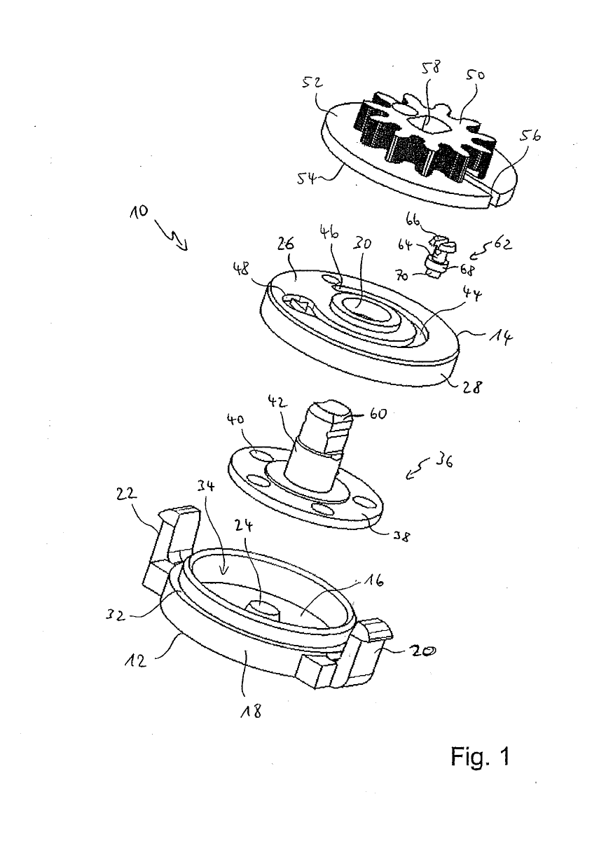

FIG. 1 shows an exploded illustration, in perspective, of the damper device according to the invention,

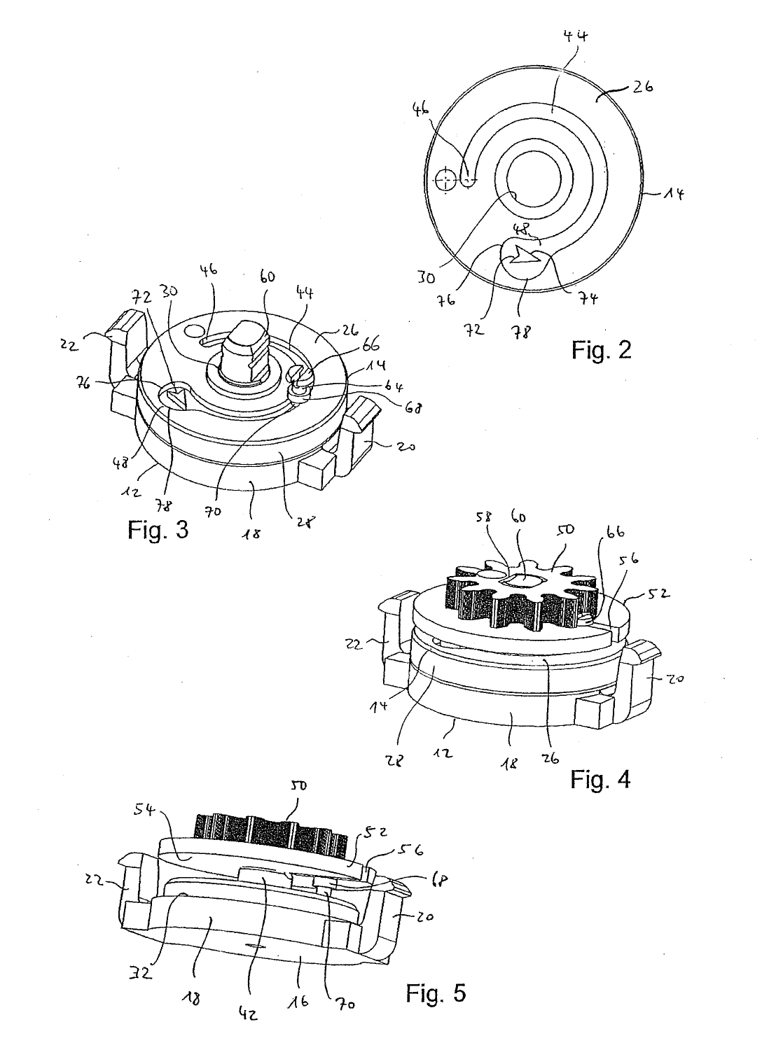

FIG. 2 shows a plan view of a housing cover of the damper device according to the invention from FIG. 1,

FIG. 3 shows a perspective view of part of the damper device shown in FIG. 1, this time in the assembled state,

FIG. 4 shows a perspective view of the damper device shown in FIG. 1, this time in the assembled state, and

FIG. 5 shows a further perspective view of part of the damper device shown in FIG. 1, once again in the assembled state.

Unless indicated to the contrary, the figures use the same designations to denote the same objects. The damper device 10 shown in FIG. 1 has a damper housing comprising a housing base 12 and a housing cover 14. The housing base 12 is of cup-like configuration with a circular base surface 16 and a cylindrical base wall 18 connected to the base surface 16. Two latching protrusions 20, 22 are arranged opposite one another on the outer side of the base wall 18, and these latching protrusions can be used in order for the damper device 10 according to the invention to be latched, and thus fastened, in the region of a component (not shown) which is to be damped by the damper device. Of course, it is also conceivable for the damper device to be, for example, screw-connected rather than latched. The base surface 16 has a central frustoconical elevation 24. The housing cover 14 has a cover surface 26, which is likewise circular in plan view. Starting from the periphery of the cover surface 26, a cylindrical cover wall 28 extends downward in FIG. 1. The housing cover 14, moreover, has a central opening 30, which is circular in plan view. For assembly of the damper device, the housing cover 14 is placed in position on the housing base 12, wherein the cover wall 28 is retained on a step 32 of the wall 18 of the housing base 12. In this state, the housing base 12 and the housing cover 14 delimit a largely cylindrical damper cavity 34 between them.

The damper device 10 also has a rotor 36 with a circular-disk-like rotor surface 38, which has a plurality of circular apertures 40. The rotor 36, moreover, has an essentially cylindrical shank 42 extending upward from the rotor disk 38 in FIG. 1. On its underside, which is not shown in FIG. 1, the shank 42 has an opening which corresponds to the frustoconical protrusion 24 of the housing base 12, and therefore the rotor 36 can be placed in position on the protrusion 24, in which case the rotor disk 38 is located in the damper cavity 34. For the purpose of closing the damper housing by virtue of the housing cover 14 being placed in position on the housing base 12, the shank 42 is guided through the opening 30 in the housing cover 14, and therefore the shank projects upward out of the housing. A damper fluid, for example a silicone fluid, is provided in the damper cavity 34.

It can also be seen in FIG. 1 that a groove 44 is formed in the upper side 26 of the housing cover 14. The groove 44 is located opposite the damper cavity 34 and forms a locking curve. It extends in circular form from a beginning 46 to an end 48, at which a heart curve is formed. In the example illustrated, moreover, the damper device 10 has a gearwheel 50, which is arranged on a circular gearwheel disk 52. Of course, instead of the gearwheel 50, it would also be possible to provide some other force transmitting element, for example a driver or a lever arm. In the example illustrated, the gearwheel 50 is connected in one piece to the gearwheel disk 52. The gearwheel disk 52 has an underside 54 which is directed away from the gearwheel 50, is located opposite the upper side 26 of the housing cover, this upper side being provided with the groove 44, and is adapted to the same in respect of shape and size. Moreover, the gearwheel disk 52 has formed in it an elongate aperture 56, which starts from the periphery of the disk 52 and extends in the radial direction as far as the gearwheel 50. A central opening 58, which is not rotationally symmetrical, is formed through the gearwheel 50 and the gearwheel disk 52. The geometry of this opening corresponds to an end 60 of the shank 42, this end not being rotationally symmetrical either, and therefore the gearwheel disk 52 with the gearwheel 50 can be fastened on the shank end 60 when the damper device 10 is in the assembled state.

The damper device 10 also comprises a locking pin 62. The locking pin 62 has a cylindrical basic body 64 with a widened, flange-like head 66 provided at one end. A second flange 68 is also provided on the cylindrical basic body 64. Flanges 66 and 68 delimit between them a cylindrical portion, by way of which the locking pin 62 can be introduced laterally into the aperture 56 in the gearwheel disk 52, and therefore the locking pin 62 is retained axially in the aperture 56. The locking pin 62 is also fixed in the aperture 56 in the circumferential direction of the gearwheel disk. In the radial direction, in contrast, the locking pin 62 is movable in the elongate aperture. At its end which is directed away from the head 66, the locking pin 62, in turn, has a cylindrical portion 70, which engages with the groove 44 when the damper device 10 is in the assembled state.

The locking curve formed by the groove 44 can be seen in the plan view in FIG. 2. It can be seen, in particular, that the groove 44 extends along a circular path from its beginning 46 to the end 48. The end 48 has a heart curve which is known per se and has a locking surface 72 which is open in the form of a V in the direction away from the groove 44. In FIG. 3, for reasons of clarity, the damper device 10 is illustrated in the assembled state, but without the gearwheel disk with the gearwheel 50. It can be seen how the locking pin 62 is guided in the groove 44. FIG. 4 shows the damper device 10 in the fully assembled state. For reasons of clarity, the housing cover 14 is not illustrated in FIG. 5. The gearwheel 50 may engage, for example, with a rack (not shown), which is connected to the component (not shown) which is to be damped by the damper device. The rack may be, for example, curved, wherein the component may be a covering which can be pivoted about a pivot axis. Pivoting of the component moves the rack correspondingly, wherein this movement results in the gearwheel 50 rotating.

Rotation of the gearwheel 50 also gives rise to rotation of the rotor 36 in the damper fluid located in the damper cavity 34. The axis of rotation of the gearwheel 50 and of the gearwheel disk 52, and also of the rotor 36, is located along the longitudinal axis of the rotor shank 42. Rotation of the gearwheel 50 with the gearwheel disk 52 also gives rise to a rotary movement of the locking pin in the groove 44. It is possible for the component to be prestressed, for example, into an open position, in which the gearwheel is located in such a rotary position that the locking pin 62 is arranged at the beginning 46 of the groove 44. If the component is then closed, the corresponding movement of the gearwheel 50 means that the locking pin 62, starting from the beginning 46, is guided initially in circular form through the groove 44 to the end 48. That is to say, in the first instance, rotation in the clockwise direction in FIG. 2 takes place. The locking pin 62 here strikes against the deflecting surface 74 of the heart curve and is directed further as far as an end surface 76 of the end 48. For this purpose, the locking pin has to execute a radial movement, wherein it moves within the radial aperture 56. In this rotary position, the component has been moved as far as it can go in its closing direction. If the component is then released, on account of it being prestressed into the open position for example by a spring, it executes a small return movement, wherein it is also the case that the gearwheel 50 is rotated back a little way in a second direction of rotation, which is counter to the first direction of rotation and is in a counterclockwise direction in FIG. 2.

The locking pin 62 here is received by the locking surface 72 of the heart curve, and it is therefore not possible for the gearwheel 50 to rotate any further in the second direction of rotation, and thus for the component to open. If it is intended for the component, for example the covering, then to be opened again, it is pushed on again in the closing-position direction, wherein the gearwheel 50 rotates a little way again in the first direction of rotation, that is to say in the clockwise direction in FIG. 2. The locking pin 62 here passes to the end surface 76 again. If the component is then released, it moves automatically, once again on account of prestressing generated for example by a spring, into the open position, wherein the gearwheel 50 executes a rotary movement in the second direction of rotation, that is to say in the counterclockwise direction in FIG. 2. During this rotary movement, starting from the end surface 76, the locking pin 62 is guided past the locking surface 72 and back, along a heart-curve guide surface 78 which is at the bottom in FIG. 2, into the circular path of the groove 44 and, further on, is directed to the beginning 46 of the groove 44. In this state, the component is located in the open position. As it runs along the heart curve, the locking pin 62 is also guided radially within the aperture 56 in the gearwheel disk 52.

1. A damper device for damping the movement of a component, preferably of a component mounted in a movable manner in the interior of a motor vehicle, comprising a damper housing, which delimits a damper cavity in which a rotor is arranged such that it can be rotated about an axis of rotation, wherein the rotor is connected in a rotationally fixed manner to a force transmitting element arranged outside the damper housing, and wherein the force transmitting element is connected to the component such that it is actuated upon movement of the component,
wherein the damper housing has a first surface located in a plane running perpendicularly to the axis of rotation,
wherein the force transmitting element comprises a disk which has a second surface likewise located in a plane running perpendicularly to the axis of rotation, wherein the first and second surfacesare located opposite one another,
wherein a locking pin is retained axially on the first surface or on the second surface, and
wherein a groove which forms a locking curve is formed in the respectively other of the first and second surfaces, wherein the locking pin engages with the groove, and wherein the locking pin, upon actuation of the force transmitting element, is guided in the groove such that the force transmitting element can be locked in a releasable manner in relation to the damper housing.

2. The damper device as claimed in claim 1, wherein the force transmitting element is a gearwheel which, for actuation in a first and a second direction of actuation, can be rotated about the axis of rotation in a first or a second direction of rotation, and in that the disk is a gearwheel disk.

3. The damper device as claimed in claim 1, wherein the force transmitting element is a driver or an arm, in particular a lever arm.

4. The damper device as claimed in claim 1, wherein, starting from a beginning of the locking curve, the locking pin, upon actuation of the force transmitting element in a first direction of actuation, is locked, at one end of the locking curve, in a locking position in which actuation of the force transmitting element in a second, opposite direction of actuation is prevented, and in that the locking pin located in the locking position, upon further actuation of the force transmitting element in the first direction of actuation, is released from the locking position, and therefore the force transmitting element can be actuated in the second direction of actuation, wherein the locking pin is guided back to the beginning of the locking curve.

5. The damper device as claimed in claim 4, wherein the locking curve has a heart curve at its end.

6. The damper device as claimed in claim 4, wherein the locking curve runs in circular or helical form between the beginning end the end.

7. The damper device as claimed in claim 1, wherein the rotor has a shank which projects out of the damper housing through the first surface and is connected in a rotationally fixed manner to the disk.

8. The damper device as claimed in claim 1, wherein the damper cavity has located in it a damper fluid, in particular a silicone fluid, in which the rotor rotates upon actuation of the force transmitting element.

9. The damper device as claimed in claim 1, wherein the locking pin is mounted such that it can be moved in a radial direction in relation to the axis of rotation.

10. The damper device as claimed in claim 9, wherein the locking pin is mounted such that it can be moved radially in a radial aperture in the first surface or the second surface.
